(19) United States
(12) Patent Application Publication
(10) Pub. No.: US 2019/0140383 A1
(43) Pub. Date: May 9, 2019

(54) TERMINAL AND MANUFACTURING METHOD THEREOF

(71) Applicant: Lotes Co., LTD., Keelung (TW)

(72) Inventors: Ted Ju, Keelung (TW); Zuo Feng Jin, Keelung (TW)

(21) Appl. No.: 15/949,352

(22) Filed: Apr. 10, 2018

(30) Foreign Application Priority Data
Nov. 6, 2017 (CN) 201711074680.1

(51) Int. Cl. H01R 13/24; H01R 43/16; H01R 12/82

(52) U.S. Cl. CPC H01R 13/2457; H01R 12/82; H01R 43/16

(57) ABSTRACT

A terminal used to electrically connect a chip module to a circuit board includes: a base being flat plate shaped; an elastic arm, formed by bending and extending upward from one end of the base; a through slot, penetrating through the elastic arm such that the elastic arm forms two branches on two opposite sides of the through slot, where a contact portion is formed at an end of each branch, the two contact portions abut a same pad of the chip module, and each branch defines a center line along an extending direction thereof; and two extrusion points, provided on the two branches respectively, the two center lines being located between the two extrusion points. When the two extrusion points are extruded by a punching equipment, the two branches elastically deform toward each other, such that a distance between the two contact portions is reduced.

### CROSS-REFERENCE TO RELATED PATENT APPLICATION

This non-provisional application claims priority to and the benefit of, pursuant to 35 U.S.C. § 119(a), patent application Serial No. CN201711074680.1 filed in China on Nov. 6, 2017. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a terminal and a manufacturing method, and in particular to a land grid array (LGA) conductive terminal and a manufacturing method thereof.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An LGA (Land Grid Array) is commonly used for an encapsulated IC (Integrated Circuit) or a chip module. To meet current transmission requirements for a high-frequency signal of a chip module, the conducting portion of LGA terminals are usually punched to form a gap, such that one conducting portion is thus divided into two contact portions, and the two contact portions can be conducted with the same conductive sheet of the chip module at the same time, so as to form a plurality of conductive paths by each terminal and the chip module, thus reducing self-inductance of the terminals during a signal transmission process, and avoiding cross-talk, and thereby implementing transmission of the high-frequency signal of the chip module.

However, the conductive sheets of a current CPU are in highly-dense arrangement so as to transmit more signals, and the size thereof becomes increasingly, so it is necessary to reduce the distance between conductive terminals of an LGA electrical connector. Therefore, it is necessary to make the gaps provided on conducting portions of the conductive terminals narrow, so as to reduce the distance between the two contact portions, thereby avoiding short-circuiting of the chip module caused by the two contact portions abutting different conductive sheets of the chip module. However, with the restrictions of the manufacturing equipments, it is difficult to punch a small gap. Therefore, a heretofore unaddressed need to design an improved terminal and a manufacturing method thereof exists in the art to address the aforementioned deficiencies and inadequacies.

### SUMMARY

In view of the problems in the background, the present invention is directed to a terminal and a manufacturing method thereof, where a distance between contact portions of terminals is reduced to ensure two contact portions of the same terminal to abut the same pad of a chip module and to meet transmission of a high-frequency signal.

To solve the foregoing problems, the present invention adopts the following technical solutions: a terminal, configured to be electrically connected to a chip module, includes: a base, being flat plate shaped; an elastic arm, formed by bending and extending upward from one end of the base, the elastic arm having a through slot, two branches and two contact portions, wherein the through slot penetrates through the elastic arm such that the elastic arm forms the two branches on two opposite sides of the through slot, each of the two contact portions is formed at an end of one of the two branches, the two contact portions abut a same pad of the chip module, and each of the branches defines a center line along an extending direction thereof; and two extrusion points, provided on the two branches respectively, the two center lines being located between the two extrusion points, wherein when the two extrusion points are extruded by a punching equipment, the two branches elastically deform toward each other, such that a distance between the two contact portions is reduced.

In certain embodiments, the two extrusion points are symmetrically provided about a center line of the through slot.

In certain embodiments, the two extrusion points are concavely formed on plate

In certain embodiments, each of the extrusion points is correspondingly adjacent to an outer edge of a corresponding one of the branches.

In certain embodiments, an abutting surface of each of the contact portions abutting the chip module and a corresponding one of the extrusion points are located on a same plate surface of each of the branches.

In certain embodiments, the elastic arm comprises a first arm extending upward vertically from the base, and a second arm bending and extending from the first arm, the two extrusion points are located on the first arm, and the contact portions are formed at an end of the second arm.

In certain embodiments, the extrusion points are located at a connecting location connecting the first arm to the base.

In certain embodiments, the two extrusion points are concavely formed on outer edges of the branches respectively.

In certain embodiments, the distance between the two contact portions is smaller than a half of a width of the through slot.

In certain embodiments, each of the contact portions is formed by bending from a free end of each of the branches toward a direction away from the plate surface of each of the branches.

In certain embodiments, an upper surface of each of the contact portions tilts downward to form a chamfer.

A manufacturing method of a terminal includes: S1: providing a metal sheet, and punching the metal sheet to form a through slot thereon, such that the metal sheet forms two branches on two opposite sides of the through slot; S2: punching off one end of each of the two branches, such that the ends of the two branches are separated from each other to form two contact portions respectively; and S3: extruding the two branches, such that the two branches elastically deform toward each other to reduce a distance between the two contact portions.

In certain embodiments, the method further includes, after the step S2, a step S21: bending free ends of the two branches away from plate surfaces of the branches, such that punching sections of the branches form the contact portions.

In certain embodiments, the method further includes, after the step S2, a step S22: bending the two branches, such that each of the branches forms a first arm being vertical and a second arm bending and extending from the first arm, wherein each of the contact portions is formed at an end of the second arm.

In certain embodiments, in step S3, the two branches are extruded to form two extrusion points, such that each of the branches forms one of the two extrusion points, and the two extrusion points are located on a plate surface or a plate edge of the first arm.

In certain embodiments, the method further includes, after the step S3, a step S31: bending free ends of the two branches away from plate surfaces of the branches, such that punching sections of the branches form the contact portions.

In certain embodiments, the method further includes, after the step S3, a step S32: bending the two branches, such that each of the branches forms a first arm being vertical and a second arm bending and extending from the first arm, wherein each of the contact portions is formed at an end of the second arm.

In certain embodiments, a specific method for extruding the branches in step S3 includes: fixing the branches to a fixed die, and then providing a punch, wherein a force applying block is provided on a lower surface of the punch, wherein when the punch approaches the fixed die, the force applying block extrudes the branches and forms an extrusion point on each of the branches; and wherein each of the branches defines a center line along an extending direction thereof, and the center lines of the two branches are located between the two extrusion points.

Another technical solution is as follows. A terminal, configured to electrically connect a chip module to a circuit board, includes: a base, having a vertical plane; a first arm, extending upward vertically from the base; a second arm, formed by bending and extending from the first arm away from the vertical plane, and then bending and extending reversely across the vertical plane, wherein an end of the second arm is configured to abut the chip module, a through slot is provided on the first arm and the second arm, the through slot penetrates through the second arm and extending to the first arm, such that the first arm and the second arm form two branches on two opposite sides of the through slot, and each of the branches defines a center line along an extending direction thereof; two extrusion points, provided on the two branches corresponding to the first arm respectively, the two center lines being located between the two extrusion points, wherein when the two extrusion points are extruded by a punching equipment, the two branches elastically deform toward each other, such that a distance between the two contact portions is reduced; a bending portion, formed by bending from an opposite end of the base and extending downward; and a conducting portion, formed by bending and extending from the bending portion, and configured to conducting the circuit board.

In certain embodiments, a through hole penetrates through the base and the bending portion, the through hole has an upper edge in the base, and a distance between inner edges of the two extrusion points is greater than or equal to a length of the upper edge.

Compared with the related art, the present invention has the following beneficial effects.

The two center lines are located between the two extrusion points, such that when the two extrusion points are extruded by the punching equipment, the metal sheet expands inward, and the two branches elastically deform toward each other, such that a distance between the two contact portions is reduced, thereby ensuring the two contact portions of each terminal to abut the same pad of the chip module during dense arrangement of the terminals, and preventing the chip module from short-circuiting.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective view of a terminal according to a first embodiment of the present invention.

FIG. 2 is a front view of a terminal according to the first embodiment of the present invention.

FIG. 3 is a schematic view illustrating a state change of a terminal before and after being pressed by a chip module according to the first embodiment of the present invention.

FIG. 4 is a flowchart showing steps S1 to S3 of a manufacturing method of a terminal according to one embodiment of the present invention.

FIG. 5 is a schematic view showing the changes of the terminal in steps S1 to S3 of the manufacturing method of a terminal according to one embodiment of the present invention.

FIG. 6 is a schematic view of a punching equipment in operation during execution of step S3 of the manufacturing method of a terminal according to one embodiment of the present invention.

FIG. 7 is a a schematic view showing the changes of the terminal in steps S3 to S31 of the manufacturing method of a terminal according to one embodiment of the present invention.

FIG. 8 is a schematic view showing the changes of the terminal in steps S2 to S21 to S3 of the manufacturing method of a terminal according to one embodiment of the present invention.

FIG. 9 is a perspective view of a terminal according to a second embodiment of the present invention.

FIG. 10 is a front view of a terminal according to the second embodiment of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

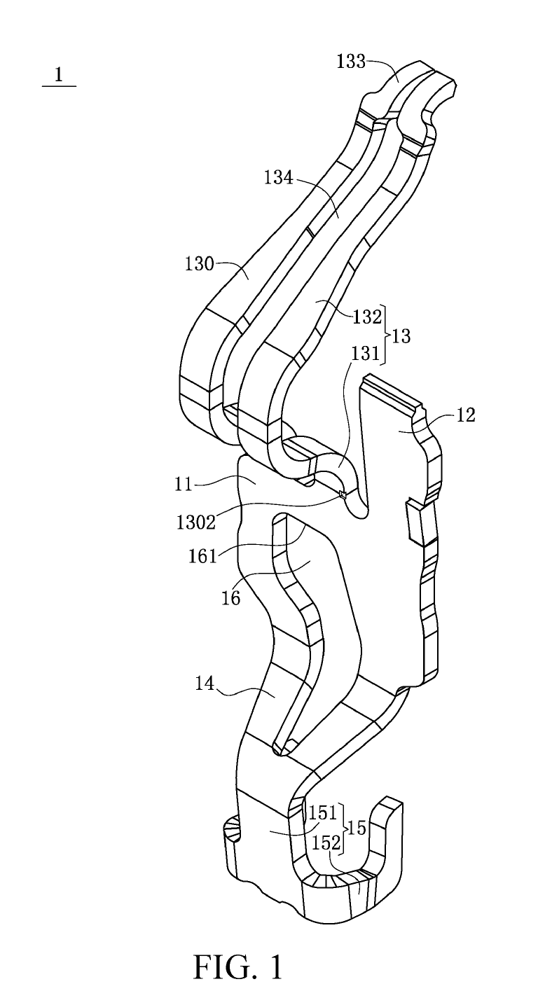

The description will be made as to the embodiments of the present invention in conjunction with the accompanying drawings in FIGS. 1-10. In accordance with the purposes of this invention, as embodied and broadly described herein, this invention, in one aspect, relates to a terminal and a manufacturing method thereof.

FIG. 1 to FIG. 3 show a terminal 1 according to a first embodiment of the present invention. The terminal 1 of the embodiment is mounted to an electrical connector (not shown in the figures, similarly hereinafter) and is used for electrically connecting a chip module 3 to a circuit board 4, which includes a base 11, two contact portions 133 located at an upper end of the base 11, and a conducting portion 15 located at a lower end of the base 11.

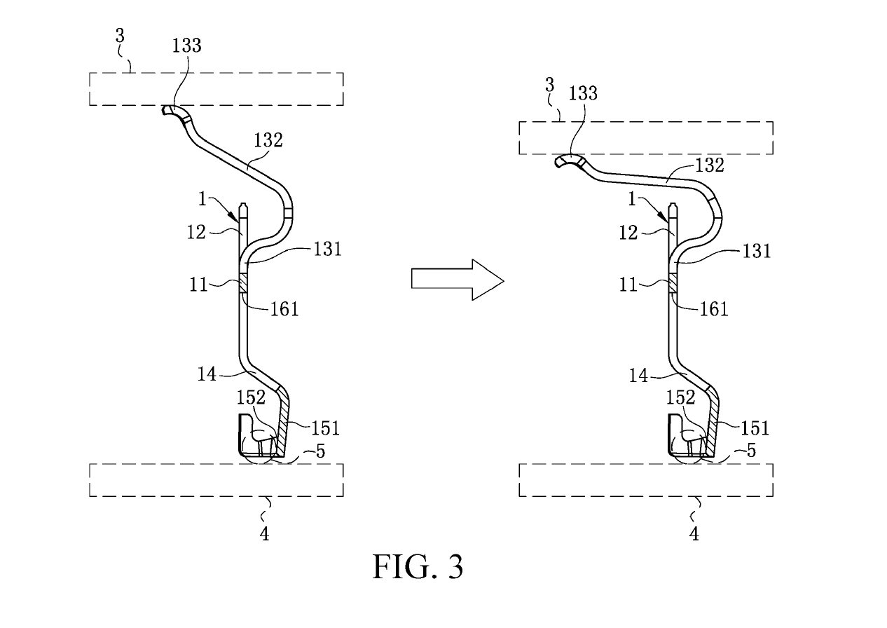

As shown in FIG. 1 and FIG. 3, specifically, the terminal 1 is formed by punching a metal sheet. The base 11 has a vertical plane, a strip connecting portion 12 is formed by extending upward vertically from the upper end of the base 11, and an elastic arm 13 is formed by bending and extending upward from the upper end of the base 11. The strip connecting portion 12 is used for connecting a strip (not shown in the figures), and the elastic arm 13 elastically abuts the chip module 3. Further, the elastic arm 13 includes a first arm 131 extending upward vertically from the base 11, and a second arm 132 formed by bending and extending from the first arm 131 away from the vertical plane, and then bending and extending reversely across the vertical plane. The contact portions 133 are formed at the end of the second arm 132 and abut the chip module 3. Such an arrangement increases the elasticity of the elastic arm 13 and ensures a good electrical contact between the terminal 1 and the chip module 3.

A through slot 134 penetrates through the elastic arm 13 vertically, and the through slot 134 extends upward to the contact portions 133 and extends downward to a connecting location connecting the first arm 131 to the base 11. Thus, a length of the through slot 134 in the elastic arm 13 is increased to the greatest extent, the self-inductance of the elastic arm 13 is reduced, cross-talk between the adjacent terminals 1 is reduced, and the elasticity of the elastic arm 13 is also increased. In other embodiments, the through slot 134 does not extend to the connecting location connecting the first arm 131 to the base 11. As long as the through slot 134 can extend to the first arm 131 along an extending direction of the elastic arm 13, the self-inductance effect of the terminal 1 can be significantly improved.

The elastic arm 13 forms two branches 130 on two opposite sides of the through slot 134. The two contact portions 133 are formed at ends of the two branches 130 respectively, and a gap is provided between the two contact portions 133, such that the two contact portions 133 are disconnected. Thus, each terminal 1 has two independent contact areas abutting the chip module 3, so as to increase contact points between the terminal 1 and the chip module 3, such that each terminal 1 and the chip module 3 form a plurality of conductive paths, and the high-frequency signal transmission capacity of the terminal 1 is enhanced.

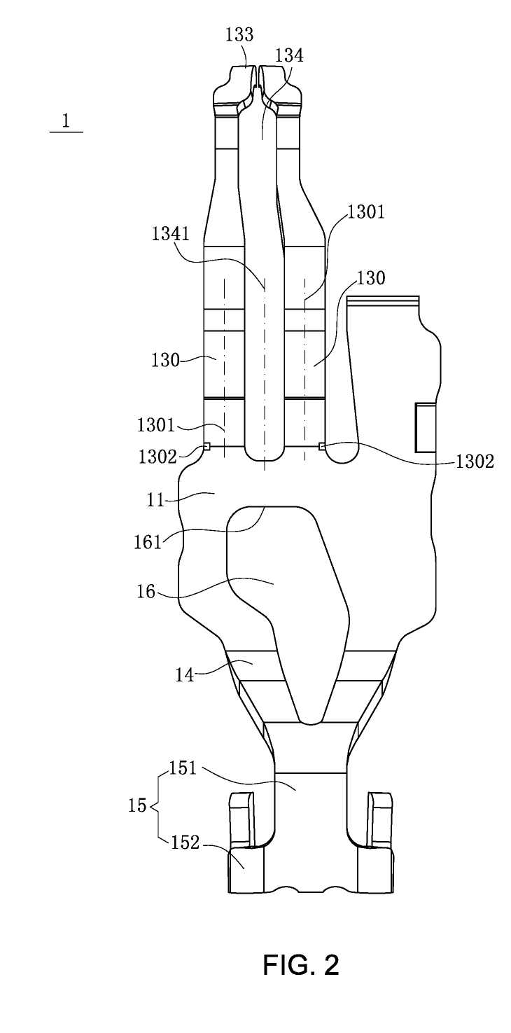

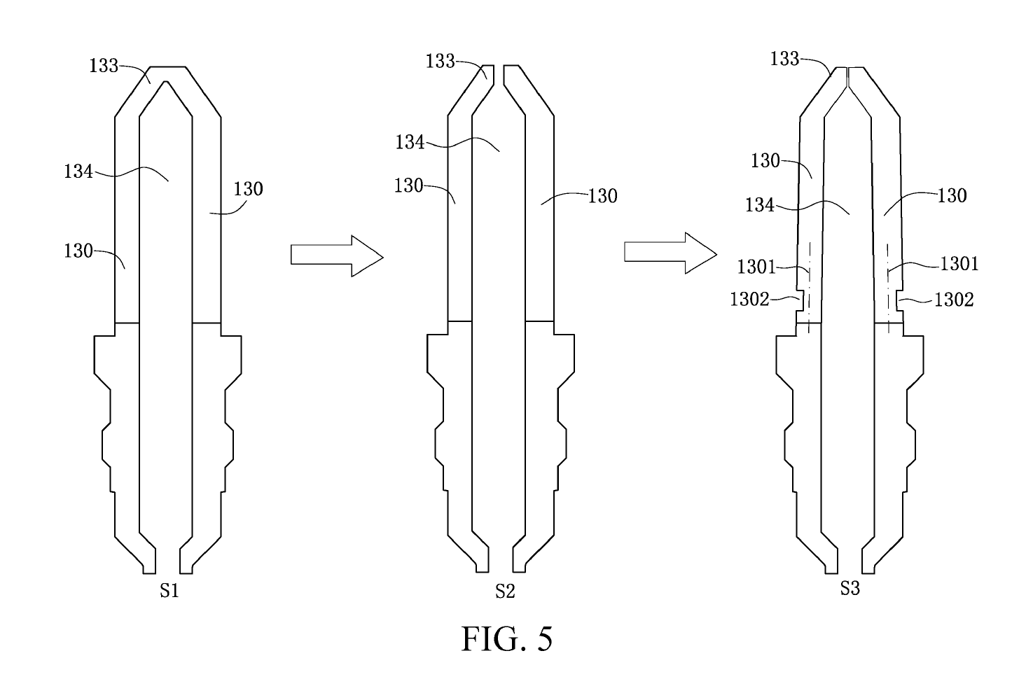

As shown in FIG. 2, FIG. 3 and FIG. 5, each branch 130 defines a center line 1301 along an extending direction thereof. Two extrusion points 1302 are provided on the two branches 130 corresponding to the first arm 131 respectively, and the two center lines 1301 are located between the two extrusion points 1302. When the two extrusion points 1302 are extruded by a punching equipment 2, the metal sheet expands inward, and the two branches 130 elastically deform toward each other, such that a distance between the two contact portions 133 can be reduced, thereby preventing the two contact portions 133 from abutting different pads of the chip module 3 during an elastic deformation process of the elastic arm 13, and further preventing the chip module 3 from short-circuiting. Further, to balance the elastic deformation amounts of the two branches 130, the two extrusion points 1302 are symmetrically provided about a center line 1341 of the through slot 134. The extrusion points 1302 are concavely formed on plate surfaces of the two branches 130 respectively, and each extrusion point 1302 is correspondingly adjacent to an outer edge of the corresponding branch 130. An abutting surface of each of the contact portions 133 abutting the chip module 3 and a corresponding one of the extrusion points 1302 are located on a same plate surface of each of the branches 130, such that it is convenient for the punching equipment 2 to apply a force thereon, so as to reduce the molding difficulty of the terminal 1. In addition, a distance between the two contact portions 133 is much smaller than a width of the through slot 134. That is, the distance between the two contact portions 133 is not greater than the half width of the through slot 134, thereby further ensuring that the two contact portions 133 of the same terminal 1 can abut the same pad of the chip module 3 at the same time. In this embodiment, the extrusion points 1302 are located at a connecting location connecting the first arm 131 to the base 11. In other embodiments, the extrusion points 1302 may be located at any other locations, as long as the two center lines 1301 of the two branches 130 are located between the two extrusion points 1302. When the punching equipment extrudes the extrusion points 1302, the branches 130 are elastically deformed, so as to reduce the distance between the two contact portions 133.

Further, the width of the through slot 134 is greater than a thickness of the terminal 1 and smaller than a width of each branch 130, thus avoiding the weak strength of the terminal 1 caused by an excessively large width of the through slot 134, and avoiding the minimized influence of the through slot 134 on the self-inductance effect of the terminal 1 caused by an excessively small width of the through slot 134, thereby achieving a balance in the structural strength and functional demand of the terminal 1. Preferably, in this embodiment, the thickness of the terminal 1 is 0.08 mm.

As shown in FIG. 1 to FIG. 3, a bending portion 14 is formed by bending from the base 11 and extending downward, and a conducting portion 15 is formed by bending and extending from the bending portion 14 and is used for conducting the circuit board 4. Specifically, the conducting portion 15 includes a connecting portion 151 formed by bending and extending downward from the bending portion 14, and two clamping portions 152 formed by bending and extending from two opposite sides of the connecting portion 151 for co-clamping a solder 5 and being soldered to the circuit board 4 via the solder 5. The bending portion 14 and the connecting portion 151 are located on the same side of the base 11, and a width of the bending portion 14 is reduced gradually along a downward direction, thereby increasing the elasticity of the bending portion 14.

A through hole 16 penetrates through the base 11 and extends from the base 11 to the bending portion 14, but does not extend to the conducting portion 15. That is, the through slot 134 penetrates through the base 11 and the bending portion 14 and does not penetrate through the conducting portion 15. Thus, the self-inductance effect of the terminal 1 can be further reduced. Moreover, it is also ensured that the conducting portion 15 is strong enough. Further, the through hole 16 has an upper edge 161 in the base 11, and a distance between inner edges of the two extrusion points 1302 is greater than or equal to a length of the upper edge 161, thereby avoiding an excessively short distance between the two extrusion points 1302 which causes excessively small elastic deformation of the terminal 1 extruded by the punching equipment 2, and avoiding a risk of insufficient reduction of the distance between the two contact portions 133.

As shown in FIG. 2 and FIG. 3, when the terminal 1 is soldered to the circuit board 4 and the chip module 3 is stably pressed down on the terminal 1, each terminal 1 can form four conductive paths, namely two conductive paths being in parallel with each other from two opposite sides of the through slot 134 and the through hole 16 downward from the top, and two crossed conductive paths from the left side of the through slot 134 to the right side of the through hole 16 and from the right side of the through slot 134 to the left side of the through hole 16. By means of the four conductive paths, the high-frequency signal transmission capability of the terminal 1 is improved.

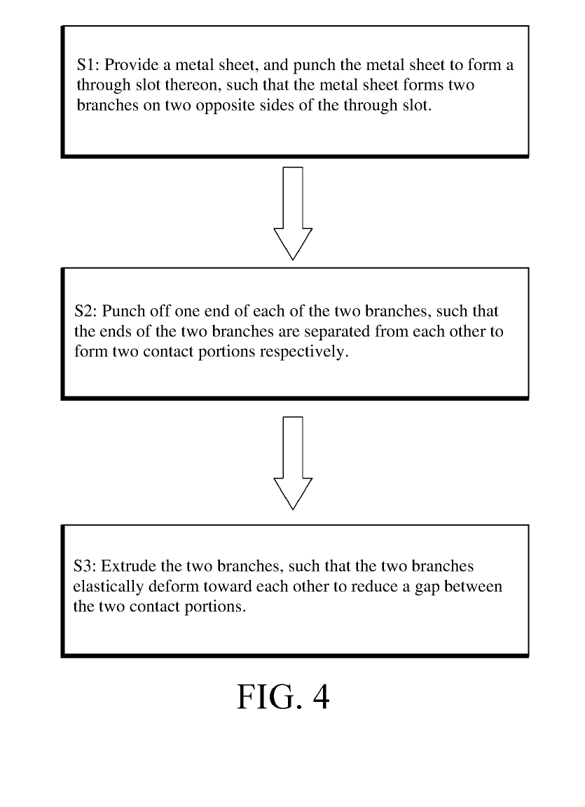

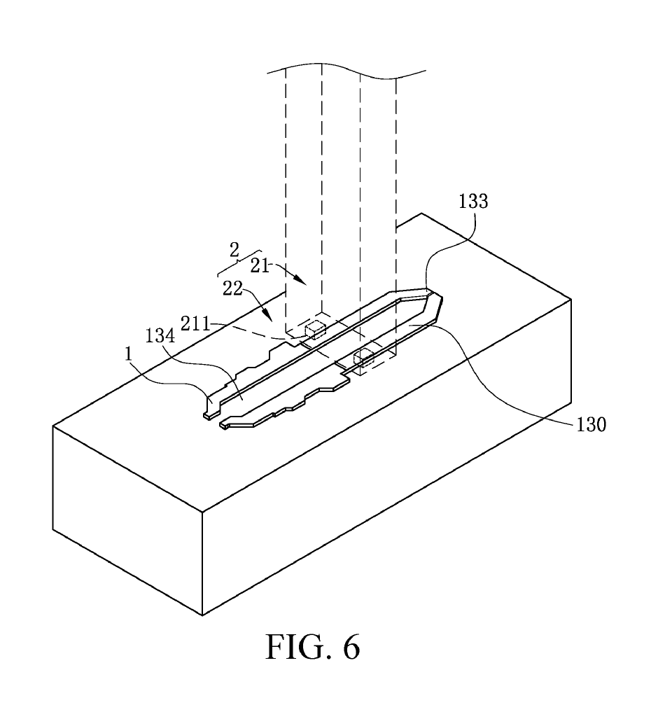

As shown in FIG. 4 and FIG. 5, a manufacturing method of the terminal 1 of the present invention includes: S1: providing a metal sheet, and punching the metal sheet to form the through slot 134 thereon, such that the metal sheet forms the two branches 130 on two opposite sides of the through slot 134. S2: punching off one end of each of the two branches 130, such that the ends of the two branches 130 are separated from each other to form two contact portions 133 respectively. It should be noted that, when the connecting ends of the two branches 130 are punched off and separated, plate surfaces of the connecting ends of the two branches 130 are stressed in the same direction, and when the two branches are separated, a small piece of material at the stressed location is disengaged from the metal sheet material due to the punching force, thereby forming the gap between free ends of the two branches 130. S3: extruding the two branches 130, such that the two branches 130 elastically deform toward each other to reduce a distance between the two contact portions 133. Specifically, as shown in FIG. 6, in step S3, the punching equipment 2 includes a fixed die 22 and a punch 21. The branches 130 are fixed to the fixed die 22, and a force applying block 211 is provided on a lower surface of the punch 21. When the punch 21 approaches the fixed die 22, the force applying block 211 extrudes the branches 130 and forms an extrusion point 1302 on each branch 130, and the center lines 1301 of the two branches 130 are located between the two extrusion points 1302. Thus, after the extrusion points 1302 are stressed, the metal sheet expands inward, and the two branches 130 elastically deform toward each other to reduce the distance between the two contact portions 133, thus preventing the two contact portions 133 from abutting different pads of the chip module 3 during elastic deformation of the terminal 1 pressed by the chip module 3, thereby ensuring the two contact portions 133 of each terminal 1 to abut the same pad of the chip module 3, and preventing the chip module 3 from short-circuiting.

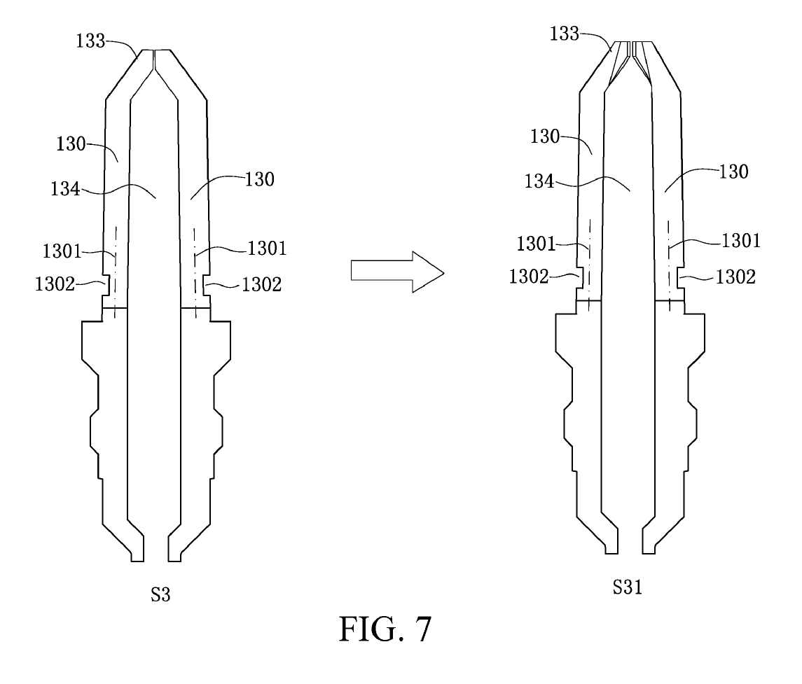

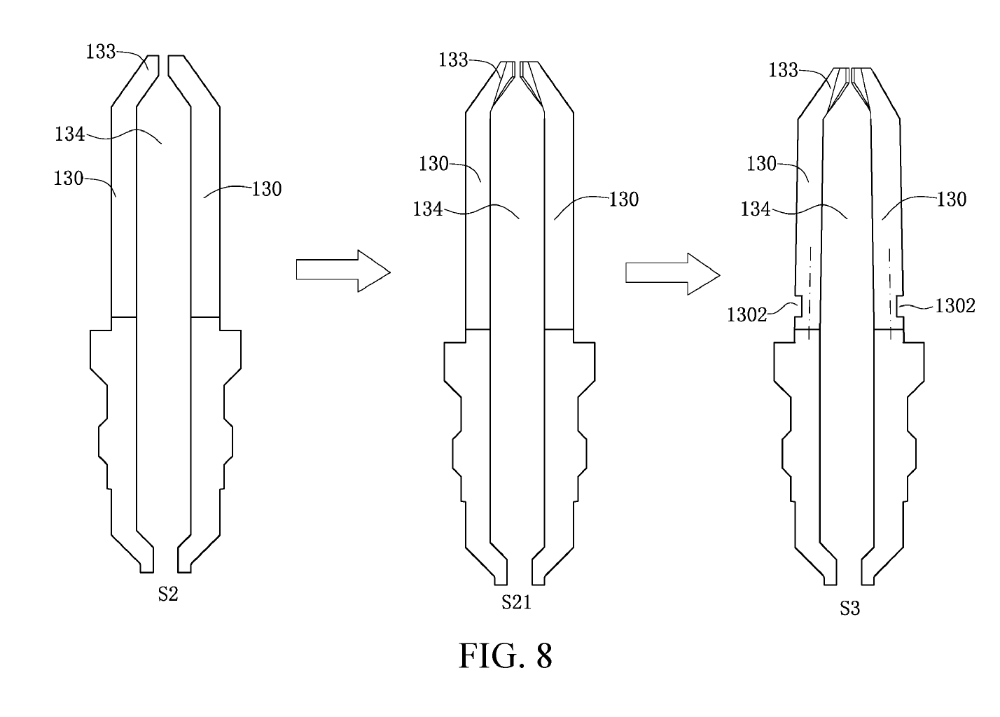

It should be particularly noted that, as shown in FIG. 7, after step S3, it is optional to perform a step S31: bending free ends of the two branches 130 away from plate surfaces of the branches 130, such that punching sections of the branches 130 form the contact portions 133, thereby reducing the contact area between the contact portions 133 and the chip module 3 (as shown in FIG. 3), and facilitating dense arrangement of pads on the chip module 3. Alternatively, after step S3, it is optional to perform a step S32: bending the two branches 130, such that each of the branches 130 form a first arm 131 being vertical and a second arm 132 bending and extending from the first arm 131, where each of the contact portions 133 are formed at an end of the second arm 132, so as to form the terminal 1 in the first embodiment (as shown in FIG. 1). As shown in FIG. 8, in another method, the step S31 or the step S32 may be performed before step S3 is completed and after step S2 is completed, thus becoming a step S21 or a step S22. Specifically, the action of the step S21 is identical to that of the step S31, and the action of the step S22 is identical to that of the step S32, and the details of these steps are not elaborated herein.

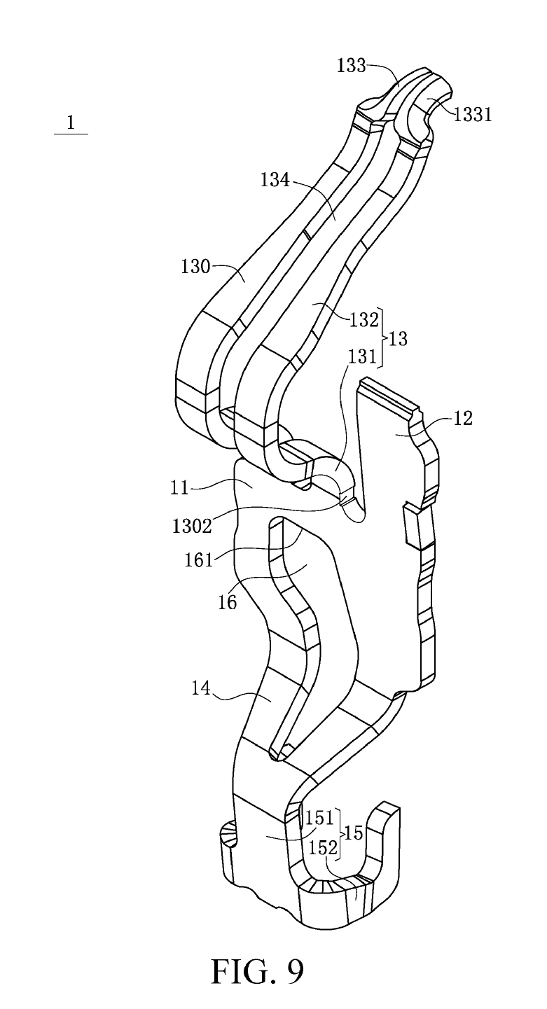

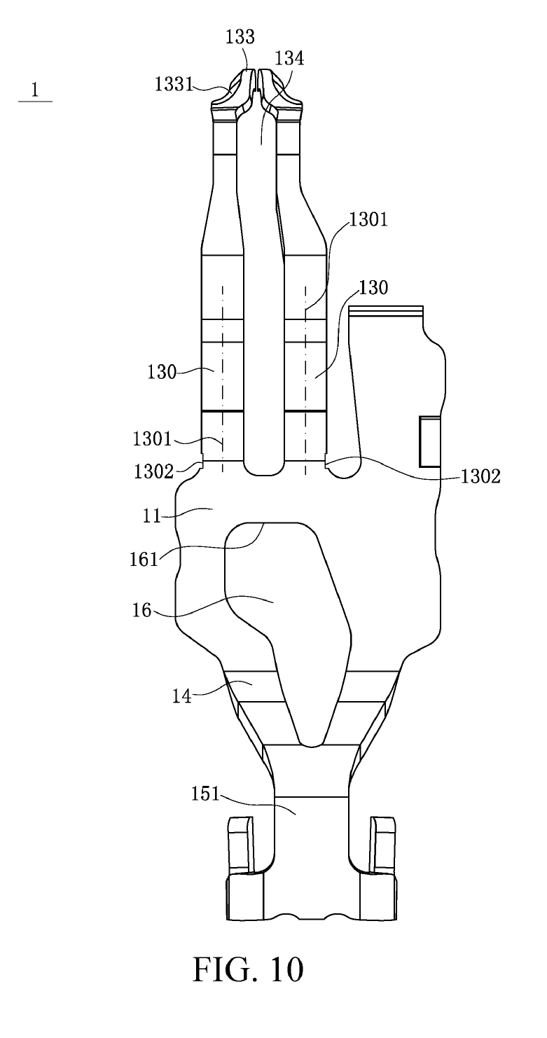

FIG. 9 and FIG. 10 show the terminal 1 according to a second embodiment of the present invention. The difference between this embodiment and the first embodiment lies in that an upper surface of each contact portion 133 tilts downward to form a chamfer 1331, such that a contact area between each of the contact portions 133 and the pad of the chip module 3 (as shown in the figures) is reduced, reducing a risk of the contact portions 133 sliding out of the pad of the chip module 3 (as shown in the figures). The two extrusion points 1302 are concavely formed on plate edges of the branches 130 respectively. Other structures and functions of this embodiment are identical to those of the first embodiment, and are not elaborated herein.

To sum up, the terminal 1 according to certain embodiments of the present invention has the following beneficial effects.

(1) The two center lines 1301 are located between the two extrusion points 1302. When the two extrusion points 1302 are extruded by a punching equipment 2, the metal sheet expands inward, and the two branches 130 elastically deform toward each other, such that a distance between the two contact portions 133 can be reduced, thereby preventing the two contact portions 133 from abutting different pads of the chip module 3 during an elastic deformation process of the elastic arm 13, and further preventing the chip module 3 from short-circuiting.

(2) The through slot 134 penetrates through the elastic arm 13, and the through hole 16 penetrates through the base 11 and the connecting portion 151, such that each terminal 1 forms four conductive paths, namely two conductive paths being in parallel with each other from two opposite sides of the through slot 134 and the through hole 16 downward from the top, and two crossed conductive paths from the left side of the through slot 134 to the right side of the through hole 16 and from the right side of the through slot 134 to the left side of the through hole 16. By means of the four conductive paths, the high-frequency signal transmission capability of the terminal 1 is improved.

(3) The free ends of the two branches 130 bend away from plate surfaces of the branches 130, such that punching sections of the branches 130 form the contact portions 133, thereby reducing the contact area between the contact portions 133 and the chip module 3, and facilitating dense arrangement of pads on the chip module 3.

(4) The through hole 16 has an upper edge 161 in the base 11, and a distance between inner edges of the two extrusion points 1302 is greater than or equal to a length of the upper edge 161, thereby avoiding an excessively short distance between the two extrusion points 1302 which causes excessively small elastic deformation of the terminal 1 extruded by the punching equipment 2 and results in a risk of insufficient reduction of the distance between the two contact portions 133.

(5) The upper surface of each contact portion 133 tilts downward to form a chamfer 1331, such that a contact area between each of the contact portions 133 and the pad of the chip module 3 is reduced, reducing a risk of the contact portions 133 sliding out of the pad of the chip module 3.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A terminal, configured to be electrically connected to a chip module, comprising:
a base, being flat plate shaped;
an elastic arm, formed by bending and extending upward from one end of the base, the elastic arm having a through slot, two branches and two contact portions, wherein the through slot penetrates through the elastic arm such that the elastic arm forms the two branches on two opposite sides of the through slot, each of the two contact portions is formed at an end of one of the two branches, the two contact portions abut a same pad of the chip module, and each of the branches defines a center line along an extending direction thereof; and
two extrusion points, provided on the two branches respectively, the two center lines being located between the two extrusion points, wherein when the two extrusion points are extruded by a punching equipment, the two branches elastically deform toward each other, such that a distance between the two contact portions is reduced.

2. The terminal of claim 1, wherein the two extrusion points are symmetrically provided about a center line of the through slot.

3. The terminal of claim 1, wherein the two extrusion points are concavely formed on plate surfaces of the branches respectively.

4. The terminal of claim 3, wherein each of the extrusion points is correspondingly adjacent to an outer edge of a corresponding one of the branches.

5. The terminal of claim 3, wherein an abutting surface of each of the contact portions abutting the chip module and a corresponding one of the extrusion points are located on a same plate surface of each of the branches.

6. The terminal of claim 1, wherein the elastic arm comprises a first arm extending upward vertically from the base, and a second arm bending and extending from the first arm, the two extrusion points are located on the first arm, and the contact portions are formed at an end of the second arm.

7. The terminal of claim 6, wherein the extrusion points are located at a connecting location connecting the first arm to the base.

8. The terminal of claim 1, wherein the two extrusion points are concavely formed on outer edges of the branches respectively.

9. The terminal of claim 1, wherein the distance between the two contact portions is smaller than a half of a width of the through slot.

10. The terminal of claim 1, wherein each of the contact portions is formed by bending from a free end of each of the branches toward a direction away from the plate surface of each of the branches.

11. The terminal of claim 1, wherein an upper surface of each of the contact portions tilts downward to form a chamfer.

12. A manufacturing method of a terminal, comprising:
S1: providing a metal sheet, and punching the metal sheet to form a through slot thereon, such that the metal sheet forms two branches on two opposite sides of the through slot;
S2: punching off one end of each of the two branches, such that the ends of the two branches are separated from each other to form two contact portions respectively; and
S3: extruding the two branches, such that the two branches elastically deform toward each other to reduce a distance between the two contact portions.

13. The manufacturing method of a terminal of claim 12, further comprising, after the step S2, a step S21: bending free ends of the two branches away from plate surfaces of the branches, such that punching sections of the branches form the contact portions.

14. The manufacturing method of a terminal of claim 12, further comprising, after the step S2, a step S22: bending the two branches, such that each of the branches forms a first arm being vertical and a second arm bending and extending from the first arm, wherein each of the contact portions is formed at an end of the second arm.

15. The manufacturing method of a terminal of claim 14, wherein in step S3, the two branches are extruded to form two extrusion points, such that each of the branches forms one of the two extrusion points, and the two extrusion points are located on a plate surface or a plate edge of the first arm.

16. The manufacturing method of a terminal of claim 12, further comprising, after the step S3, a step S31: bending free ends of the two branches away from plate surfaces of the branches, such that punching sections of the branches form the contact portions.

17. The manufacturing method of a terminal of claim 12, further comprising, after the step S3, a step S32: bending the two branches, such that each of the branches forms a first arm being vertical and a second arm bending and extending from the first arm, wherein each of the contact portions is formed at an end of the second arm.

18. The manufacturing method of a terminal of claim 12, wherein a specific method for extruding the branches in step S3 comprises:
fixing the branches to a fixed die, and then providing a punch, wherein a force applying block is provided on a lower surface of the punch,
wherein when the punch approaches the fixed die, the force applying block extrudes the branches and forms an extrusion point on each of the branches; and
wherein each of the branches defines a center line along an extending direction thereof, and the center lines of the two branches are located between the two extrusion points.

19. A terminal, configured to electrically connect a chip module to a circuit board, comprising:
a base, having a vertical plane;
a first arm, extending upward vertically from the base;
a second arm, formed by bending and extending from the first arm away from the vertical plane, and then bending and extending reversely across the vertical plane, wherein an end of the second arm is configured to abut the chip module, a through slot is provided on the first arm and the second arm, the through slot penetrates through the second arm and extending to the first arm, such that the first arm and the second arm form two branches on two opposite sides of the through slot, and each of the branches defines a center line along an extending direction thereof;
two extrusion points, provided on the two branches corresponding to the first arm respectively, the two center lines being located between the two extrusion points, wherein when the two extrusion points are extruded by a punching equipment, the two branches elastically deform toward each other, such that a distance between the two contact portions is reduced;
a bending portion, formed by bending from an opposite end of the base and extending downward; and
a conducting portion, formed by bending and extending from the bending portion, and configured to conducting the circuit board.

20. The terminal of claim 19, wherein a through hole penetrates through the base and the bending portion, the through hole has an upper edge in the base, and a distance between inner edges of the two extrusion points is greater than or equal to a length of the upper edge.
